(19) United States
(12) Patent Application Publication
(10) Pub. No.: US 2020/0356094 A1
(43) Pub. Date: Nov. 12, 2020

(54) METHODS AND SYSTEMS FOR MACHINE STATE RELATED VISUAL FEEDBACK IN A ROBOTIC DEVICE

(71) Applicant: Diversey, Inc., Fort Mill, SC (US)

(72) Inventors: Aurle Y. Gagne, Mechanicsville, VA (US); Philip Scarim, Troutville, VA (US); David M. Knuth, JR., North Chesterfield, VA (US)

(21) Appl. No.: 16/407,557

(22) Filed: May 9, 2019

(51) Int. Cl. G05D 1/02; G01S 17/93; G01S 7/497

(52) U.S. Cl. CPC G05D 1/024; G01S 7/497; G01S 17/936

(57) ABSTRACT

A robotic device including a plurality of light emitting modules and a processor is disclosed. The processor is configured to identify one or more machine states of the robotic device and a status of each of the one or more machine states, select at least one of the one or more machine states, determine a visual pattern corresponding to a status of the at least one selected machine state, cause the plurality of light emitting modules to output the visual pattern. The one or more machine states include one or more of the following: a navigation state, a sensor function state, a collision alert state, or an error state.

### BACKGROUND

The present disclosure is in the technical field of robotic device operation, particularly providing visual feedback corresponding to the status of robotic devices (e.g., robotic cleaning devices).

Robotic devices have the ability to minimize the human effort involved in performing everyday tasks. For example, robotic devices may be used as cleaning devices to help maintain and clean surfaces, such as hard floor surfaces, carpets, and the like. Although there are benefits to greater independence for autonomous vehicles, increased independence can also lead to insufficient information being readily available to human operators or bystanders relating to the vehicle's operation.

A robotic device typically observes its environment during the performance of the task. For example, a robotic device can sense when it has encountered an obstacle and, optionally, attempt to circumvent the obstacle. Such robotic devices are equipped with a variety of sensors that collect data corresponding to the environment in which a robotic device operates in, and the sensor data may be used for navigation and/or for performing various tasks. Proper and accurate functioning of the sensors of a robotic device is critical for its functions.

Troubleshooting a robotic device because of sensor malfunction is difficult because of two reasons. First, a user may not know that a sensor of the robotic device has malfunctioned. For example, a light detection and ranging (LiDAR) sensor of a robotic cleaning device may not be properly calibrated but the robotic device may continue to clean an area until it collides with an object leading to damages to the robotic device. Second, even if the user knows that one or more sensors of the robotic device have malfunctioned, the user may not be able to identify the particular sensor(s) that has malfunctioned and/or how the sensor(s) malfunctioned to be able to repair the sensor.

This document describes devices and methods that are intended to address issues discussed above and/or other issues.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an embodiment, systems and methods for conveying information relating to the machine state of a robotic device using a plurality of light emitting modules. The method may include by a processor of a robotic device identifying one or more machine states of the robotic device and a status of each of the one or more machine states, selecting at least one of the one or more machine states, determining a visual pattern corresponding to a status of the at least one selected machine state, and causing a plurality of light emitting modules of the robotic device to output the visual pattern. The one or more machine states may include a navigation state, a sensor function state, a collision alert state, and/or an error state. The method may be performed by a processor of robotic device, where the robotic device also includes a plurality of light emitting modules.

Optionally, selecting the at least one of the one or more machine states may include making the selection based on, for example and without limitation, a priority level associated with each of the one or more machine states, a priority level associated with the status of each of the one or more machine states, mode of operation of the robotic device, and/or user instructions.

In certain embodiments, determining the visual pattern may include identifying, corresponding to the status of the at least one machine state, one or more characteristics of the visual pattern. Examples of characteristics may include, without limitation, one or more colors of light in the visual pattern, intensity of light in the visual pattern, shape of light in the visual pattern, identification of the plurality of light emitting modules, and/or variations in one or more characteristics of the light pattern over time.

In at least one embodiment, the navigation state may correspond to a movement of the robotic device. In such embodiments, a status in the navigation state may provide information about at least one of the following: direction of movement, impending turns, or impending stops during the movement of the robotic device.

In certain embodiments, the sensor function state may correspond to a machine state of the robotic device in which one or more of a plurality of sensors of the robotic device are activated. In such embodiments, a status in the sensor function state may provide information about at least one of the following: identity of a sensor that is activated, location of the sensor on the robotic device, type of the sensor, distance of the robotic device from an object being sensed by sensor, location of an object being sensed by the sensor, or type of object being sensed by the sensor.

In one or more embodiments, the method may also include performing preventive maintenance of the robotic device by selecting the at least one machine state as the sensor function state, operating the robotic device in an environment, receiving the visual pattern corresponding to the sensor function state of the robotic device from the robotic device, determining whether at least one sensor of the robotic device has malfunctioned by analyzing the received visual pattern, and outputting results of the determination. Information about one or more objects in the environment may be known before the operation of the robotic device in the environment. Optionally, determining if the at least one sensor of the robotic device has malfunctioned by analyzing the received visual pattern may include analyzing the visual pattern to determine information about at least one of the one or more objects in the environment detected by the at least one sensor of the robotic device. The information may include, for example, distance of the robotic device from the at least one object, location of the at least one object relative to the robotic device, and/or type of the at least one object. Alternatively and/or additionally, determining if the at least one sensor of the robotic device has malfunctioned by analyzing the received visual pattern may include comparing the information about the at least one object with the corresponding known information, and determining that the at least one sensor has malfunctioned if the information about the at least one object with the corresponding known information do not match.

In some embodiments, the method may also include performing calibration of one or more sensors of the robotic device using the visual pattern.

In certain embodiments, the collision alert state may correspond to a machine state of the robotic device in which the robotic device may collide with an object within a threshold time. A status in the collision alert state may provide information about at least one of the following: distance of the robotic device from the object, location of the object relative to the robotic device, or type of user intervention needed.

In one or more embodiments, the error state may correspond to a machine state of the robotic device in which the at least one component of the robotic device is not functioning as expected. A status in the error state may provide information about at least one of the following: identity of the at least one component, time duration in the error state, or criticality of an error.

In at least one embodiment, the method may also include using the outputted visual pattern during LiDAR calibration of a LiDAR sensor included in the robotic device. Optionally, using the outputted visual pattern during LiDAR calibration of the LiDAR sensor included in the robotic device may include causing one or more of the plurality of light emitting modules of the robotic device to output a first visual pattern in response to detecting an object located at a distance that is equal to a detection range of the LiDAR sensor, and causing one or more of the plurality of light emitting modules of the robotic device to output a second visual pattern in response to not detecting the object. A height of the object may be equal to a height of a focal plane of the LiDAR sensor with respect to a surface on which the robotic device is placed.

In certain other aspects of this disclosure, a method and system for performing preventive maintenance of a robotic device is disclosed. The method may include operating the robotic device in an environment. The method may also include by a processor: receiving a visual pattern corresponding to a status of at least one sensor of the robotic device, determining whether the at least one sensor of the robotic device has malfunctioned by analyzing the received visual pattern, and outputting results of the determination.

In certain embodiments, the status may provide information about at least one of the following: whether or not the at least one sensor is activated, location of the at least one sensor on the robotic device, type of the at least one sensor sensor, distance of the robotic device from an object being sensed by the at least one sensor, location of an object being sensed by the at least one sensor sensor, or type of object being sensed by the at least one sensor.

Optionally, determining if the at least one sensor of the robotic device has malfunctioned by analyzing the received visual pattern may include analyzing the visual pattern to determine information about at least one of the one or more objects in the environment detected by the at least one sensor of the robotic device. In such embodiments, the information may include one or more of the following: distance of the robotic device from the at least one object, location of the at least one object relative to the robotic device, or type of the at least one object.

In some embodiments, determining if the at least one sensor of the robotic device has malfunctioned by analyzing the received visual pattern may include comparing the information about the at least one object with the corresponding known information, and determining that the at least one sensor has malfunctioned if the information about the at least one object with the corresponding known information do not match.

### BRIEF DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 depicts a block diagram of an example robotic device, in accordance with the embodiments described in this document;

FIGS. 2A and 2B depict example arrangements of light emitting modules on a robotic device, in accordance with the embodiments described in this document;

FIG. 3 depicts an embodiment of an example system that includes the robotic device shown in FIG. 1, in accordance with the embodiments described in this document;

FIG. 4 illustrates a flowchart for an example method of providing a visual feedback corresponding to machine state information of a robotic device, in accordance with the embodiments described in this document;

FIG. 5 illustrates a flowchart for an example method of performing preventive maintenance in a robotic device using a visual feedback, in accordance with the embodiments described in this document;

FIG. 6 depicts a block diagram of an example LiDAR sensor mounted on a robotic device, in accordance with the embodiments described in this document; and

FIG. 7 depicts an example of internal hardware that may be included in any of the electronic components of the system, in accordance with the embodiments described in this document.

### DETAILED DESCRIPTION

The present disclosure describes embodiments for providing visual feedback for aiding in the navigation of robotic devices such as robotic cleaning devices in an environment. The visual feedback may be generated based on a machine state of the robotic device and may be generated to provide information about the machine state to a user.

As used in this document, any word in singular form, along with the singular forms “a,” “an” and “the,” include the plural reference unless the context clearly dictates otherwise. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used in this document, the term “comprising” means “including, but not limited to.”

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a light fixture is oriented in a first direction. The relative orientations of the components may be reversed, or the components may be on the same plane, if the orientation of a light fixture that contains the components is changed. The claims are intended to include all orientations of a device containing such components.

The terms “computing device” and “electronic device” refer to a device having a processor and a non-transitory, computer-readable medium (i.e., memory). The memory may contain programming instructions in the form of a software application that, when executed by the processor, causes the device to perform one or more processing operations according to the programming instructions. An electronic device also may include additional components such as a touch-sensitive display device that serves as a user interface, as well as a camera for capturing images. An electronic device also may include one or more communication hardware components such as a transmitter and/or receiver that will enable the device to send and/or receive signals to and/or from other devices, whether via a communications network or via near-field or short-range communication protocols. If so, the programming instructions may be stored on the remote device and executed on the processor of the computing device as in a thin client or Internet of Things (IoT) arrangement. Example components of an electronic device are discussed below in the context of FIG. 8.

The terms “memory,” “memory device,” “computer-readable medium” and “data store” each refer to a non-transitory device on which computer-readable data, programming instructions or both are stored. Unless the context specifically states that a single device is required or that multiple devices are required, the terms “memory,” “memory device,” “computer-readable medium” and “data store” include both the singular and plural embodiments, as well as portions of such devices such as memory sectors.

A “processor” or “processing device” is a hardware component of an electronic device that is configured to execute programming instructions. The term “processor” may refer to a single processor or to multiple processors that together implement various steps of a process. Unless the context specifically states that a single processor is required or that multiple processors are required, the term “processor” includes both the singular and plural embodiments.

As used herein, the term “robot” or “robotic device” refers to an electro-mechanical machine guided by a processor. The robotic device may also include a memory that may contain programming instructions in the form of a software application that, when executed by the processor, causes the device to perform one or more processing operations according to the programming instructions. A robotic device also may include one or more communication hardware components such as a transmitter and/or receiver that will enable the device to send and/or receive signals to and/or from other devices, whether via a communications network or via near-field or short-range communication protocols. If so, the programming instructions may be stored on the remote device and executed on the processor of the robotic device as in a thin client or Internet of Things (IoT) arrangement. Mobile robotic devices have the capability to move around in their environment and are not fixed to one physical location. An example of a mobile robotic device that is in common use today is an automated guided vehicle or automatic guided vehicle (AGV). An AGV is generally a mobile robot that follows markers or wires in the floor, or uses electromagnetic emitter-detectors, including for example sonar, a vision system or lasers for navigation. Mobile robots can be found in industry, military and security environments. They also appear as consumer products, for entertainment or to perform certain tasks like vacuum cleaning and home assistance.

Mobile robotic devices may interact or interface with humans to provide a number of services that range from home assistance to commercial assistance and more. In the example of home assistance, a mobile robotic device can assist elderly people with everyday tasks, including, but not limited to, maintaining a medication regime, mobility assistance, communication assistance (e.g., video conferencing, telecommunications, Internet access, etc.), home or site monitoring (inside and/or outside), person monitoring, and/or providing a personal emergency response system (PERS). For commercial assistance, the mobile robotic device can provide videoconferencing (e.g., in a hospital setting), a point of sale terminal, interactive information/marketing terminal, etc. Mobile robotic devices need to navigate in a robust or reliable manner, for example, to avoid obstacles and reach intended destinations.

The term “machine state” of a robotic device refers to the state of the robotic device about which it is providing a visual feedback at any point in time. Examples of such machine states may include, without limitation, navigation state (e.g., providing information relating to the direction of movement of the robotic device in an environment); sensor function state (e.g., providing information relating to the operation of a sensor of the robotic device); collision alert state (e.g., providing information relating to objects detected in the environment); error state (e.g., providing information relating to malfunctioning of one or more components of the robotic device); or the like. A machine state may have a “status” associated with it that may provide additional information about the machine state such as the distance to an object in the collision alert state, type of object in a collision alert state, time associated with an upcoming turn in a navigation state, criticality of an error in an error state, or the like. Other machine states and statuses are within the scope of this disclosure.

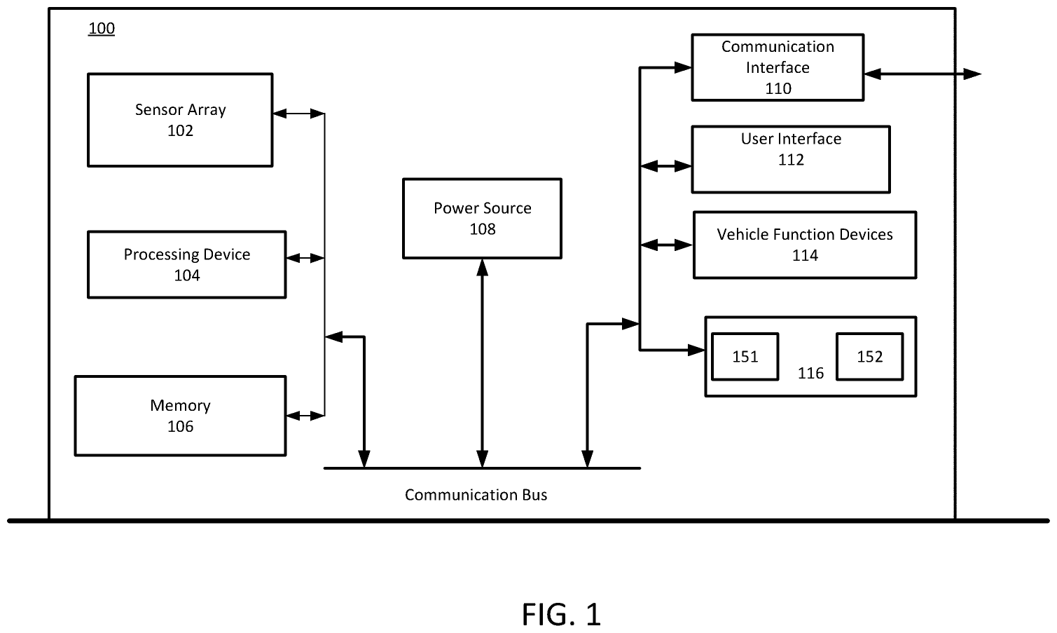

FIG. 1 illustrates a block diagram of components of an example embodiment of a robotic device 100. The components and interaction of components described with respect to the robotic device 100 may be implemented in any other embodiments of robotic devices. In addition, the embodiments of robotic devices described herein are also not limited to the components and interaction of components described with respect to the robotic device 100, but can be implemented in a number of other ways. In an embodiment, the robotic device 100 may be an autonomous device that is capable of automatically navigating its environment.

The robotic device may include, without limitation, one or more sensors 102, a processing device 104, a memory 106, a power source 108, a communications interface 110, a user interface 112, one or more vehicle function devices 114, and one or more light emitting modules 116.

In certain embodiments, the one or more sensors 102 may include one or more sensors located on the robotic device 100 and may be configured to provide information about the robotic device 100 itself and/or the environment around the robotic device 100. For example, the one or more sensors 102 may include a proximity sensor configured to detect a distance from the robotic device to any object in a field of the proximity sensor. Examples of proximity sensors include infrared sensors, light detection and ranging (LiDAR) sensors, global positioning system (GPS) devices, cameras, other electromagnetic energy sensors, sonar sensors, other forms of acoustic sensors, and other forms of proximity sensors. The one or more sensors 102 may also include sensors to detect an orientation or heading of the robotic device 100, such as a gyroscope or a compass, or to detect a speed and/or acceleration of the robotic device 100, such as an accelerometer or encoders. The one or more sensors 102 may also include sensors that detect characteristics about the environment around the robotic device 100, such as a temperature sensor (e.g., a thermocouple or a thermistor), a humidity sensor (e.g., a hygrometer), a pressure sensor (e.g., a barometer, a piezoelectric sensor), infrared (IR) sensor, or any other sensor.

In some embodiments, the processing device 104 may be configured to control one or more functions of the robotic device 100 such as, without limitation, navigation in an environment, cleaning (if a cleaning robotic device), communication with a user or an external system, or the like. In some embodiments, the processing device 104 is configured to control the movements of the robotic device 100 based on, without limitation, readings from the one or more sensors 102, a digital map of the environment, readings from one or more sensors in the environment, a predefined path of movement, or any other information, or combinations thereof. For example, in an embodiment, the processing device may receive information from the one or more sensors 102 and analyze it to control the navigation of the robotic device 100. The robotic device 100 also includes memory 106 and the processing device may write information to and/or read information from the memory 106. For example, one or more rules for generating a virtual boundary may be stored in the memory 106 and the processing device 104 may read the data from the memory 106 to aid in controlling movements of the robotic device.

The processing device 104 may communicate with each of the other components of the robotic device 100, via for example, a communication bus or any other suitable mechanism.

In one or more embodiments, a communications interface 110 may be configured to facilitate communication of data into and out of the robotic device 100. In some embodiments, the communications interface 110 may include, without limitation, a WiFi transceiver, a Bluetooth transceiver, an Ethernet port, a USB port, and/or any other type of wired and/or wireless communication interfaces. The communications interface 110 is configured to transmit data to and receive data from computing devices and/or networks that are not included in the robotic device 100.

In certain embodiments, the user interface 112 may include any type of input and/or output devices that permit a user to input commands into or receive information from the robotic device 100. In some embodiments, the user input/output devices 112 may include, without limitation, a push button, a toggle switch, a touchscreen display, an LED light interface, a keyboard, a microphone, a speaker, or any other kind of input and/or output device. The user input/output devices 112 may permit a user to control the operation of the robotic device 100, define settings (e.g., modes) of the robotic device 100, receive information about operations of the robotic device 100, troubleshoot problems with the robotic device 100, or the like.

In one or more embodiments, the vehicle functional devices 114 of the robotic device 100 may include any device that is capable of causing the robotic device 100 to function in a particular way. In some embodiments, the vehicle functional devices 114 may include one or more motors that drive wheels of the robotic device 100 to cause it to move. In some other embodiments, the vehicle functional devices 114 may include a steering mechanism to control a direction of movement of the robotic device 100. In some embodiments, the vehicle functional devices 114 may include a cleaning device configured to clean a surface on which the robotic device 100 moves (e.g., a sweeper, vacuum, mop, polisher, fluid dispenser, squeegee, or the like). The vehicle functional devices 114 can include any number of other functional devices that cause the robotic device 100 to function. In some embodiments, the processing device 104 may also be configured to control operation of the vehicle functional devices 114.

In some embodiments, the power source 108 is configured to provide power to the other components of the robotic device 100. The power source 108 may be coupled to and capable of providing power to each of the one or more sensors 102, the computing device 104, the memory 106, the communications interface 110, the user interface 112, and/or the vehicle function devices 114. The power source 108 may include one or more of a rechargeable battery, a non-rechargeable battery, a solar cell panel, an internal combustion engine, a chemical reaction power generator, or any other device configured to provide power to the robotic device 100 and its components.

In certain embodiments, each of the one or more light emitting modules 116 may include one or more light emission devices 151 (e.g., a light-emitting diode (LED), a light pipe, or the like). The light emitting modules 116 may also include one or more optical components 152 for controlling light emitted by the one or more LEDs. For example, an optical component may include a lens structure made from a suitable material such as, without limitation, silicone, glass, clear resin, epoxy, or the like. In an embodiment, the lens structure may include a design configured to emit light according to a desired pattern (such as intensity, color angle, direction, etc.). In an embodiment, light emitting modules 116 may include LEDs of different colors or groups of LEDS comprising different colors (such as green, yellow, blue and red, among others) with each group comprising LEDs of the same colors. In an embodiment, a light emitting module 116 may simultaneously display multiple colors. For example, the light emitting modules 116 may include a red LED and a green LED may be mounted adjacent to one another behind a lens cover. When the red LED is activated and the green LED is turned off, red light will be emitted. Green light will be emitted when the red LED is off and the green LED is on. Amber light may be produced by simultaneously activating both the green and red LEDs.

The processing device 104 may control the operation of the one or more light emitting modules 116 to provide visual feedback about one or more machine states of the robotic device 100 using a light pattern. The processing device 104 may send and/or receive control signal to and/or from the light emitting modules 116 via one or more protocols (such as I²C, PWM, analog, digital, or the like). In one embodiment, the processing device 104 may adjust properties of light emitted by the light emitting modules 116 (e.g., the brightness, color, pattern, timing, and on/off) to display the machine states(s) and corresponding status(es) of a robotic device. The processing device 104 may adjust properties of light emitted by the light emitting modules 116 using various methods such as, without limitation, changing the duty cycle of pulse width modulation (PWM) to adjust the brightness and on/off of each LEDs; regulation of the amount of current supplied to each of the LEDs where the intensity of the light emitted by an LED on the amount of current supplied to the LED; controlling the color by turning on/off LEDs of one or more colors in a light emitting module; or the like.

A light pattern refers to a visual sensory output in a particular sequence or arrangement that provides, to a user, relevant information about one or more machine states of a robotic device. One or more characteristics of the visual pattern may change in real-time based on the real-time a status(es) of the one or more machine states. A visual pattern may be formed using, without limitation, visual color patterns, light intensity variations, illumination patterns, illumination shapes, illumination sizes, strategic placement of the light emitting modules, and/or a combinations thereof.

In an embodiment, a visual pattern may convey information to using one or more colors of light such as monochromatic lights or lights that can be adjusted to produce two, three, or more than three colors. For example, a red color may be used to indicate machine states in the error state, an amber color may be used to indicate machine states in the collision alert state, a green color may be used to indicate machine states in the sensor function state, and a blue color may be used to indicate machine states in the navigation state. One or more colors may also be used to distinguish between machine states in the same category. For example, different colors may be used to indicate the operation of different sensors of the same type and/or different types of sensors in the sensor function state, different types of errors in the errors state, different types of movement (e.g., forward versus backwards) in the navigation state, different types of objects detected (e.g., stationary object, stairs, moving object, wall, etc.) in the collision alert state.

In another example, a visual pattern may be formed by varying the intensity of light (e.g., from a low level to a high level or vice versa). For example, a visual pattern may include increasing the intensity of light based on the increase (or decrease) in distance from an object in the collision alert state, based on the increase (or decrease) in time the robotic device has been in an error state, based on the criticality of an error in the error state, or the like.

A visual pattern may also be formed using different illumination patterns such as without limitation, solid or steady, flickering, flickering with different patterns and/or rates, increasing/decreasing in size, etc. For example, a solid light may be used to convey information about a stopped robotic device and a flickering pattern may be used to convey information about a robotic device moving forward in the navigation state. In an embodiment, a visual pattern may include increasing the rate of flickering of light based on based on the increase (or decrease) in distance from an object in the collision alert state, based on the increase (or decrease) in time the robotic device has been in an error state, based on the criticality of an error in the error state, or the like.

In yet another example, a visual pattern may be formed using illumination patterns that create different shapes (for e.g., by selective illumination of LEDs) such as a line shape formed by illuminating adjacent light emitting modules in a straight line, a ring shape, a circle, moving line (form left to right, right to left, etc.) and/or a combinations thereof. Different shapes may be associated with different machine states.

In one or more embodiments, a visual pattern may be formed based on the placement of the light emitting modules 116 on the robotic device 100 which in turn may be based on the machine state(s) the light emitting modules are associated with. For example, light emitting modules associated with the navigation state may be positioned on the robotic device 100 such that they can easily provide information relating to the direction of movement of the robotic device.

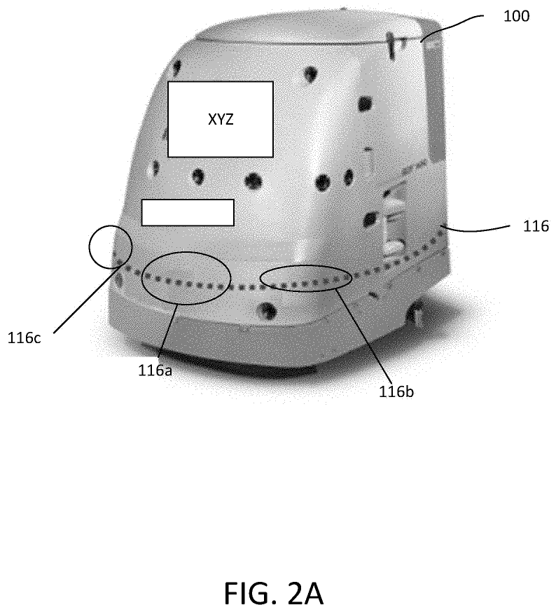

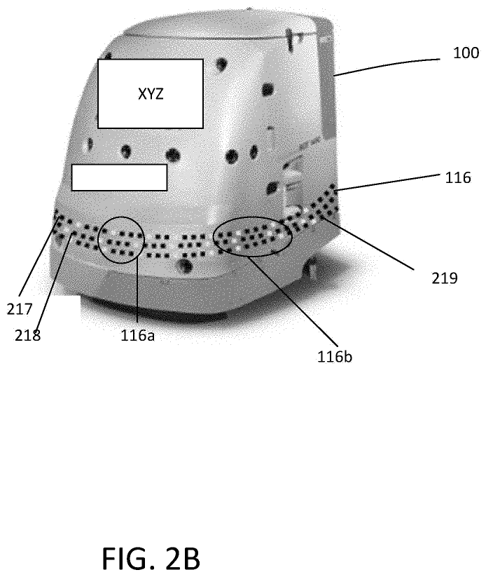

This may be accomplished by placing the light emitting modules 116 around the periphery of the robotic device 100 as shown in FIGS. 2A (in a single row) and 2B (as multiple rows). For example, the light emitting modules 116 may be arranged in one or more rows all around the housing of the robotic device 100 (as shown in FIGS. 2A and 2B). Alternatively, the light emitting modules 116 may be arranged in one or more rows at positioned on one or more sides, corners, top, etc. (but not all around) of the robotic device 100 (not shown here). As shown in FIGS. 2A and 2B, different groups of light emitting modules 116 may be turned on (and/or provide another visual pattern) to indicate the direction of movement of the robotic device (e.g., forward direction may be indicated by turning on of the light emitting modules 116(a), left turn may be indicated by turning on of the light emitting modules 116(b), right turn may be indicated by turning on of the light emitting modules 116(c), rotation in the right direction may be by a scrolling pattern moving from left to right, or the like).

Similarly, light emitting modules associated with the sensor function state may be positioned on the robotic device 100 at locations that have a defined relationship with the location of one or more sensors of the robotic device. For example, one or more light emitting modules may be positioned on the same vertical axis and/or horizontal axis as each of the sensors (e.g., sonar sensors, LiDAR sensors, etc.) of the robotic device 100. Alternatively and/or additionally, the light emitting modules may be positioned to surround at least part of a sensor (e.g., formation of a ring or other shapes around a sensor). Light emitting modules associated with the collision alert state may be positioned on the mobile device such that they are easily visible to a user who can take actions (e.g., move the object for object avoidance) in response to a visual feedback provided by the robotic device 100. Light emitting modules associated with the error state may be positioned to identify the components of the robotic device 100 that have malfunctioned and/or for easy visibility.

In certain embodiments, a light emitting module may be associated with a particular machine state of the robotic device 100 such that it conveys information about the status of that machine state only. Thus, the lighting modules of the robotic device 100 may provide information about the status of different machine states simultaneously. For example, the first row 217 of the light emitting modules may provide information relating to navigation of the robotic device 100, the second row 218 may provide about sensor function, and the third row 219 may provide information about errors and/or collision alert.

Alternatively and/or additionally, a light emitting module may be associated with more than one machine state of the robotic device 100 and may provide information about the status of a machine state based on priority and/or user instructions (as discussed below). For example, the light emitting modules shown in FIGS. 2A and 2B may be used to provide information about sensor function state, collision alert state, and/or error state, in addition to the navigation state described above, using various light patterns described below. For example, in FIG. 2A, blue color of the light emitting modules 116(b) may indicate left turn and red color and/or another pattern may indicate that a sensor located in the same vertical axis as the light emitting modules 116(b) is operating to help the robotic device 100 navigate. Similarly, a different light pattern (e.g., rapid flashing) may be used to indicate an collision alert state corresponding to an object on the left side of the robotic device 100 using the light emitting modules 116(b).

In an embodiment, one or more of the above such as color patterns, intensity variations, illumination patterns, illumination shapes, illumination sizes, and/or light emitting device locations may be combined in a visual pattern to convey information about a machine state(s), and its corresponding status, of a robotic device. For example, a red color may be used to indicate a machine state corresponding to an error state and its corresponding status (such as time) may be indicated using a flickering pattern with change in rate of flickering. Similarly, a green color may be used to indicate a machine state corresponding to a sensor function state, and the location of the light emitting module emitting the green color may be used to indicate the identity of the sensor that is operating. In another example, a blue color may be used to indicate a navigation state and a light pattern in the form of a left arrow (and/or a square on the left side light emitting modules) may indicate an impending left turn. Furthermore, the intensity of the arrow may be varied to indicate time remaining before the turn. In another example, feedback relating to the collision alert state may be provided using an amber color, and location of the light emitting module and an intensity of light may be varied based on the distance to the object. Furthermore, a blinking pattern may be used to indicate an impending collision of the robotic device with the object. In another example, continuous turning on of adjacent lights may be used to indicate that the detected object is moving in a particular direction. Different patterns (e.g., shapes, colors, etc.) may be used to indicate detection of different types of objects (e.g., stationary or moving).

It should be noted that the above visual patterns and examples are provided by way of example only and various other patterns may be used without deviating from the principles of this disclosure. Similarly, the visual pattern examples may be used to convey information about other machine states (e.g., sensor calibration, preventive maintenance, functional state, etc.). In an embodiment, a user may provide some or all of rules for identifying and/or creating the visual patterns and the associated machine state.

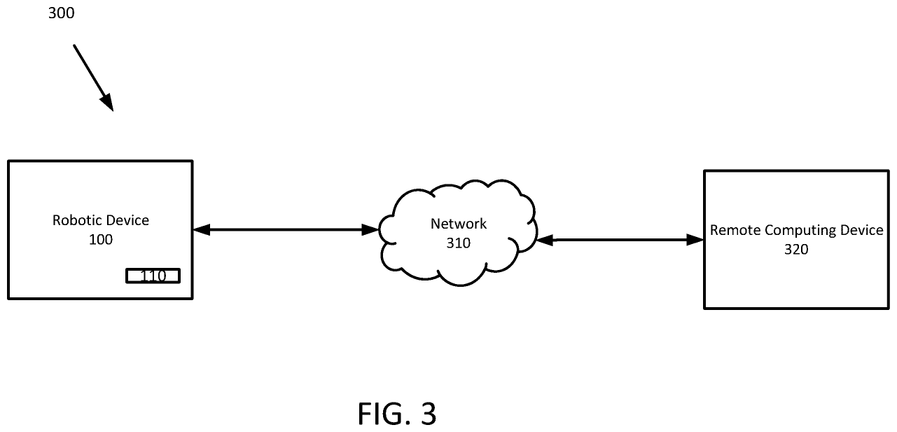

FIG. 3 illustrates an example embodiment of a system 300 that includes the robotic device 100. The system may include a network 310 that is in communication with the communications interface 310 of the robotic device 100. The network 310 may include a wireless network, a wired network, or any combination of wired and/or wireless networks. The system 300 also includes a remote computing device 320 that is located remotely from the robotic device 100, and is in communication with the robotic device 100 via the network 310. In some embodiments, the remote computing device 320 may include, without limitation, a laptop computer, a desktop computer, a server, a mobile phone, a tablet, or any other type of computing device.

In some embodiments, the robotic device 100 may operate in a facility (e.g., a building, a campus of buildings, etc.), where the network 310 may include a private network to the facility (e.g., a WiFi network associated with the facility), and the remote computing device 320 may be a computing device located in the facility at a location different from the operation of the robotic device 100. In some other embodiments, the robotic device 100 may operate in a facility (e.g., a building, a campus of buildings, etc.) where the network 310 may include a public network (e.g., the Internet), and the remote computing device 320 may be located somewhere other than the facility (e.g., in a “cloud” data center, in a facility of a distributor of the robotic device 100, etc.). It will be understood that many other arrangements of the network 310 and the remote computing device 320 are within the scope of this disclosure. It will be understood that the remote computing device 320 may be a single computing device or may be a number of computing devices that are capable of interacting with each other.

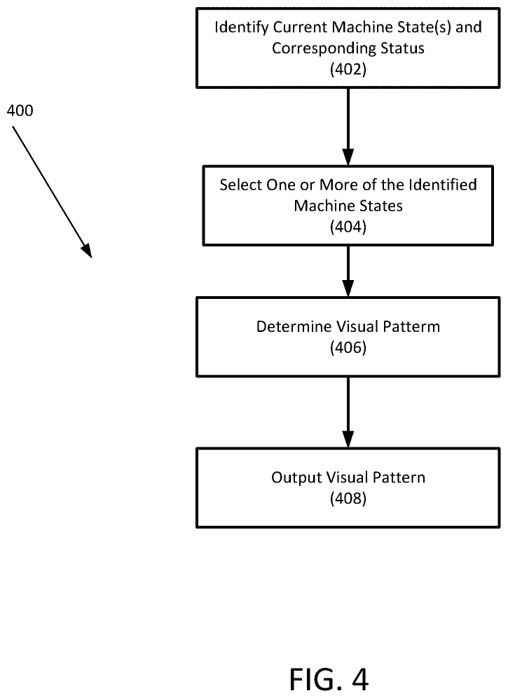

FIG. 4 illustrates an example method for conveying machine state information of a robotic device using a visual feedback. While the method 400 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 4 but the process may be integrated and/or one or more steps may be performed together, simultaneously, or the steps may be performed in the order disclosed or in an alternate order. Likewise, any setup processes described above may be integrated and/or one or more steps may be performed together, simultaneously, or the steps may be performed in the order disclosed or in an alternate order.

At 402, the system may identify the current machine state(s) of the robotic device and their corresponding status. As discussed above, examples of machine states may include a navigation state, a sensor function state, a collision alert state, and an error state. The system may identify the machine states and corresponding status based on information received from one or more components of the robotic device (e.g., vehicle function devices that move the robotic device, sensor array, user interface, etc.)

In certain embodiments, the system may identify that the robotic device is operating in a navigation state if, for example, it is moving, preparing or scheduled to move within a certain time period, and/or stopped for a short duration between movements. The statuses associated with the navigation state may include, direction of movement (forward, backward, rotation in one place), impending turns (e.g., left turn, right turn, partial left, partial right turn, direction of rotation, pivot, etc.), pause, or the like.

The system may identify that the robotic device is in a sensor function state if one or more sensors of the robotic device are activated and/or collecting data. The status of the sensor function state may include information relating to, for example, identity of the sensor(s) that is activated, location of the sensor(s) that is activated, type of sensor(s) that is activated, distance from an object being sensed by the activated sensor(s), location of an object being sensed by the activated sensor(s), type of object being sensed by the activated sensor(s) (e.g., staircase, wall, furniture, carpet area, etc.) or the like.

The system may identify that the robotic device is in an collision alert state if it determines that it is going to collide with an object within a certain time and/or it needs user intervention to prevent the collision (e.g., when one or more sensors of the robotic device malfunction, the brakes of the robotic device malfunction, etc.). The collision alert state may also be used to convey information about a maneuver performed by the robotic device in order to avoid an impending collision. For example, if an object suddenly enters an area around the robotic device, the robotic device may need to abort its current course of action and, for example, suddenly back up. The status of the collision alert state may, therefore, alert a user to the reason for the sudden back up of the robotic device (and/or other deviations from the planned navigation course) and/or about an upcoming sudden move of the robotic device. The status of the collision alert state may include information relating to, for example, distance from an object, location of an object, type of object, type of user intervention needed, type of intervention/action performed to avoid collision, or the like. In certain embodiments, if a visual feedback corresponding to a collision alert state of the robotic device is conveyed in the absence of a collision danger, the visual feedback may be indicative of a sensor malfunction in the robotic device.

The system may identify that the robotic device is in an error state if it detects that one or more components (e.g., function modules, light emitting modules, sensors, user interface, etc.) of the robotic device are not functioning as expected and/or are preventing the functioning of the robotic device as expected. The status of the error state may include information relating to, for example, the identity of the component that is not functioning as expected, time duration in the error state, criticality of the error, or the like.

At 404, the system may select one or more machine states from the identified machine states, the status of which will be indicated using a visual feedback. As discussed above, the system may provide visual feedback about all the identified machine states of the robotic device at the same time (for example, using different light emitting modules).

Alternatively and/or additionally, the system may provide feedback about the identified machine states based on an order of priority (for example, if the same light emitting modules are used to provide feedback about different machine states). For example, a collision alert state may be ranked higher in priority compared to the navigation state, the senor function state, and/or the error state. Alternatively and/or additionally, a machine state priority may be based on the status of the machine state. For example, if the collision alert is for a collision that will happen within a threshold time period, it will be given higher priority over other machine states. In another example, the error state may be given higher priority over the collision alert state if its status indicates that it affects a critical function of the robotic device (e.g., collision avoidance, cleaning, etc.) and/or if the robotic device has been in the error state for more than a threshold period of time. For example, if the suctioning function of the robotic device has malfunctioned and a cleaning job is scheduled within a threshold time period, the error state may be given highest priority. In yet another embodiment, the sensor function state may be ranked highest if, for example, the robotic device is operating in a preventive maintenance mode for detecting sensor malfunction (discussed below), in a sensor calibration mode, or the like. Optionally, a user may assign priorities to different machine states. It will be understood to those skilled in the art that the same priority level may be assigned to one or more machine states. Other rules are within the scope of this disclosure.

At 406, the system may determine a visual pattern for indicating the status of the selected machine states (as described above). For example, the system may identify the color, the light emitting modules and/or their location, intensity, shape, illumination pattern, etc. to form a visual pattern corresponding to the selected machine state(s) and the corresponding status. It should be noted that the visual pattern may be updated and/or adjusted in real-time to provide real-time machine state visual feedback to a user.

The system may then output the determined visual pattern at 408 using one or more light emitting modules. For example, the system may control the selection, brightness, color, pattern, timing, and on/off of the one or more LEDs to provide a visual feedback to a user using the determined visual pattern. As is known to those skilled in the art, intensity of the LED is a function of the average current flow through the LED. In an embodiment, the system may use one or more of any now or hereafter known protocols (such as PWM, I²C, etc.) to create the visual pattern (discussed above). For example, in an embodiment, the system may generate illumination signals to the one or more light emitting modules such that the illumination signals depend upon the determined visual pattern. For example, an illumination signal delivered to a light emitting module may include information relating to drive current, voltage, color, frequency, intensity, etc. for illumination one or more LEDs in that light emitting module.

In an embodiment, the visual feedback system of the robotic device may be used to determine if a sensor of the robotic device has malfunctioned and/or get information about how it has malfunctioned. For example, a user may operate the robotic device in a preventive maintenance mode in which the robotic device only provides information relating the status of the activated sensors (all activated sensors and/or user selected group of sensors). As discussed above, status information about a sensor may include identity of the sensor(s) that is activated, location of the sensor(s) that is activated, type of sensor(s) that is activated, distance from an object being sensed by the activated sensor(s), location of an object being sensed by the activated sensor(s), type of object being sensed by the activated sensor(s) (e.g., staircase, wall, furniture, carpet area, etc.) or the like. Therefore, sensor malfunction may be detected by a user in one or more of the following scenarios: a sensor is activated and/or not activated as expected; an object is detected and/or not detected as expected; location and/or distance of the object being detected is not as expected; type of object detected is not as expected; or the like. The user may also receive more information about the sensor malfunction based on the status information provided by the visual pattern.

For example, if a visual pattern emitted by one or more light emitting modules indicates that a sonar sensor is detecting an object on the right side of the robotic device, when no objects are located on the right side, the user may determine that the sonar sensor has malfunctioned Similarly, if a visual pattern emitted by one or more light emitting modules indicates that a sonar sensor is detecting an object is located within a first distance from the robotic device when there are no objects located within that first distance and/or the object is located at a different distance, the user may determine that the sonar sensor has malfunctioned. In another example, if a visual pattern is emitted that indicates that the sensor(s) have detected a staircase at a location instead of a furniture that is actually present at that location, the user may determine that the sensor(s) have malfunctioned. In yet another embodiment, if a collision alert feedback is provided in the absence of a collision danger, it may be indicative that one or more sensors of the robotic device are sensing an object within the sensor shield of the robotic device (i.e., a collision would occur if a corrective action is not taken).

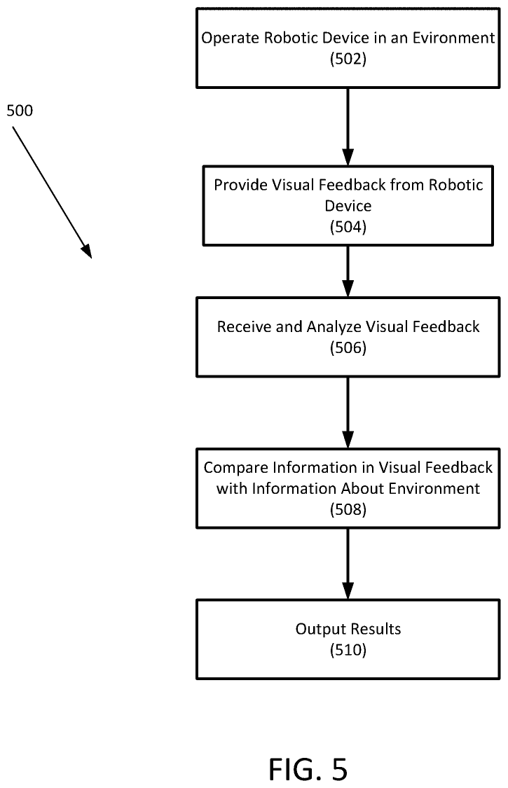

FIG. 5 illustrates an example method for performing preventive maintenance of a robotic device using a visual feedback. While the method 500 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 5 but the process may be integrated and/or one or more steps may be performed together, simultaneously, or the steps may be performed in the order disclosed or in an alternate order. Likewise, any setup processes described above may be integrated and/or one or more steps may be performed together, simultaneously, or the steps may be performed in the order disclosed or in an alternate order.

At 502, the robotic device may be operated in an environment where the layout (e.g., location and type of objects) in the environment is known.

At 504, the robotic device may provide a visual feedback corresponding to the status of one or more sensors of the robotic device during operation in the environment (as discussed above with respect to FIGS. 1 and 3). For example, light emitting diodes associated with sensors that are activated during operation may be configured to emit a visual pattern that includes light of a particular color to indicate activation, light of a particular color to indicate type of object detected, blinking rate based on distance to an object detected by the activated sensors, other patterns (e.g., arrows) to indicate location of object detected, or the like. The output may be viewed by a user and analyzed and/or may be captured by a component of the system (e.g., a mobile device) for automatic analysis.

At 506, the system (e.g., a mobile device) may receive the visual feedback and analyze it to determine information relating to one or more objects in the environment, as sensed by the activated sensors. For example, the system may analyze the visual pattern in the feedback to determine which sensors are activated and/or the characteristics of the objects (e.g., type, size, location, distance, etc.) detected by the activated sensors. The system may have access to a database that provides information about correlations between visual patterns and machine states and/or statuses. Optionally, a user may analyze the visual feedback to determine information relating to one or more objects in the environment, as sensed by the activated sensors.

At 508, the system may compare the determined information with the information about the layout of the environment in which the robotic device is operating to determine if one or more sensors of the robotic device have malfunctioned. For example, if a visual pattern emitted by one or more light emitting modules indicates that a sonar sensor is detecting an object on the right side of the robotic device, when no objects are located on the right side, the system may determine that the sonar sensor has malfunctioned. Similarly, if a visual pattern emitted by one or more light emitting modules indicates that a sonar sensor is detecting an object is located within a first distance from the robotic device when there are no objects located within that first distance and/or the object is located at a different distance, the system may determine that the sonar sensor has malfunctioned. In another example, if a visual pattern is emitted that indicates that the sensor(s) have detected a staircase at a location instead of a furniture that is actually present at that location, the system may determine that the sensor(s) have malfunctioned. Optionally, a user may determine if one or more sensors of the robotic device have malfunctioned by comparing the layout of the environment with the information relating to objects being sensed by the robotic device and the visual feedback.

At 510, the system may provide an output to a user indicating the results of the preventive maintenance process (e.g., sensors working accurately, one or more sensors of the robotic device have malfunctioned and corresponding information, etc.).

In certain embodiments, the visual feedback system of the robotic device may be used to calibrate one or more sensors (e.g. LiDAR sensors) of the robotic device.

The robotic device may use a LiDAR sensor to map the positions, sizes, shapes, and orientations of objects in an environment. In these and other such scenarios, calibration of the orientation of the LiDAR device significantly affects the achievable accuracy and/or precision of the LiDAR-based scanning Even small errors in orientation calibration, such as a small difference between a presumed orientation and an actual orientation, may result in a variety of errors. For example, a slightly heading rotation, a slight forward pitch, and/or a slight roll as compared with a presumed orientation may result in significant inaccuracies in the detected locations, orientations, sizes, shapes, surface details, and/or velocities of the scanned objects. In view of such difficulties, a calibration techniques are needed to prepare a LiDAR scanner before use.

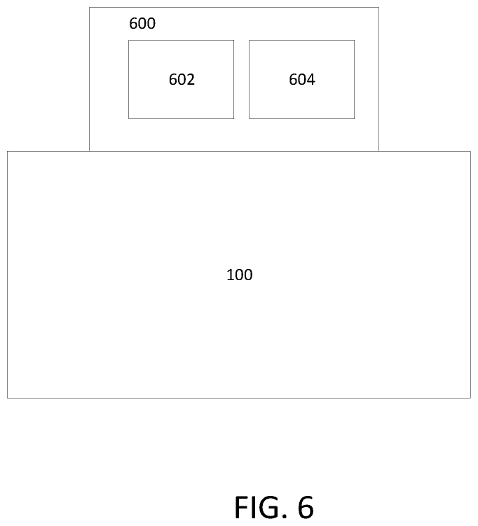

FIG. 6 illustrates a LiDAR sensor 600 that may be included in a robotic device 100. Generally, LiDAR is an optical remote sensing technology that can measure distance to, or other properties of, a target by illuminating the target with light. The light can be any type of electromagnetic waves such as laser. As an example, the LiDAR sensor 600 may include a laser source and/or laser scanner 602 configured to emit pulses of laser and a detector 604 configured to receive reflections of the laser.

The LiDAR sensor 600 may rotate with respect to the robotic device it is mounted on while projecting pulses of light in various directions, while also detecting the reflection of such pulses of light. The duration between the projection and detection for each pulse, coupled with the orientation of the LiDAR sensor 600 during the projection, enables a determination of the range between the LiDAR sensor 600 and a reflective object in the direction of the orientation. By performing such detection at a high resolution and rate in a particular radius, the LiDAR sensor 600 may generate a map of the respective points relative to the location of the LiDAR sensor 600. A registration of the respective points with a coordinate space enables the determination of volumetric pixels, or voxels, within an objective or stationary frame of reference with respect to the environment. Such registration also enables a mapping of objects within an object map with respect to the location of the robotic device. In this manner, LiDAR mapping may be utilized to detect the locations, sizes, shapes, orientations, and/or velocities of objects in the environment.

However, in such scenarios, the accuracy of LiDAR mapping is significantly dependent upon the calibration of the orientation of the LiDAR sensor 600. That is, determining the range of a particular voxel only involves detecting the duration between the projection of the light pulse and the detection of its reflection, but determining the direction of the voxel within three-dimensional space depends significantly upon precise knowledge of the orientation of the LiDAR sensor 600 during projection and/or detection. A miscalibration of the LiDAR sensor 600 along any axis or dimension with respect to a presumed orientation—e.g., exhibiting a pitch forward or backward; exhibiting a longitudinal roll; or exhibiting a planar rotation of heading—results in inaccuracies in the registration of voxels within the coordinate space. The visual feedback system of this disclosure may be used to perform LiDAR calibration.

In some embodiments, LiDAR calibration may be performed by aiming the LiDAR at a target object that has a known height. Preferably the height is the same as the height of the LiDAR plane of the LiDAR sensor on the robotic device. For performing calibration, the orientation angle of the LiDAR may be manually adjusted until the LiDAR is able to detect the target object of height that is equal to the height of the LiDAR plane, and is located at the maximum threshold of the LiDAR detection range. For example, if a LiDAR sensor can detect objects located at a distance of up to 10 meters, and the LiDAR plane is 1 foot from the floor, the LiDAR may be calibrated by placing a target object having a height of about 1 foot at a distance of 10 meters from the LiDAR. If the LiDAR can detect part of the target, it's orientation is angled down and must be adjusted upwards. On the other hand, if the LiDAR cannot detect the target at all, it's orientation is angled up and must be adjusted downwards. The LiDAR orientation at which the LiDAR changes from detecting the target object to not detecting the target object (or vice versa) is the optimal LiDAR calibration orientation (with minuscule changes in orientation). However, determining whether the LiDAR is detecting or not detecting an object with minute changes in its orientation is difficult.

The visual feedback system of the current system may be used to provide feedback to a user regarding the state of LiDAR points detected by the LiDAR of the robotic device, which may be used by the user to calibrate the LiDAR accurately and precisely. For example, one or more LEDs of the visual feedback system may be configured to provide feedback about objects detected by the LiDAR—whether or not object is detected, distance from the object, height of the object detected, or the like. During calibration, feedback provided by such one or more LEDs regarding detection of the target object may be used by a user to manually adjust the orientation of the LiDAR. For example, as discussed above, the LiDAR orientation at which the LiDAR changes from detecting the target object to not detecting the target object (or vice versa) is the optimal LiDAR calibration orientation. Therefore, a user may look for feedback from the LEDs of the visual feedback system that indicates that the LiDAR state changes from detecting to not detecting (or vice versa) with minuscule changes in orientation of the LiDAR to determine the desired optimal orientation.

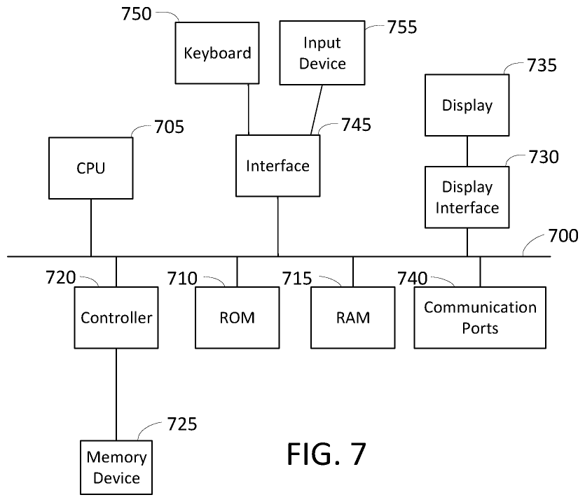

FIG. 7 depicts an example of internal hardware that may be included in any of the electronic components of the system, such as a robotic device, sensor, etc. having a processing capability, or a local or remote computing device that is in communication with the robotic device. An electrical bus 700 serves as an information highway interconnecting the other illustrated components of the hardware. Processor 705 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 725 that may store the programming instructions. A memory device may include a single device or a collection of devices across which data and/or instructions are stored. Various embodiments of the invention may include a computer-readable medium containing programming instructions that are configured to cause one or more processors, robotic devices and/or its components to perform the functions described in the context of the previous figures.

An optional display interface 730 may permit information from the bus 700 to be displayed on a display device 735 in visual, graphic or alphanumeric format. An audio interface and audio output (such as a speaker) also may be provided. Communication with external devices may occur using various communication devices 740 such as a wireless antenna, an RFID tag and/or short-range or near-field communication transceiver, each of which may optionally communicatively connect with other components of the device via one or more communication system. The communication device(s) 740 may be configured to be communicatively connected to a communications network, such as the Internet, a local area network or a cellular telephone data network.

The hardware may also include a user interface sensor 745 that allows for receipt of data from input devices 750 such as a keyboard, a mouse, a joystick, a touchscreen, a touch pad, a remote control, a pointing device and/or microphone. In embodiments where the electronic device is the smartphone or another image capturing device, digital images of a document or other image content may be acquired via an image acquisition device 720 that can capture video and/or still images.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

As will be appreciated by those skilled in the art, one or more components of the system 700 may be located remotely from other components of the system 700 components, such as in a distributed system. Furthermore, one or more of the components may be combined and additional components performing functions described herein may be included in the system 700. Thus, the system 700 can be adapted to accommodate a variety of needs and circumstances. The depicted and described architectures and descriptions are provided for exemplary purposes only and are not limiting to the various embodiments described herein.

It will be appreciated that the above-disclosed and other features and functions may be combined into many other different systems or applications. All such applications and alternatives are also intended to be encompassed by the disclosure of this patent document.

Embodiments described herein may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

As should be appreciated, various embodiments of the embodiments described herein may also be implemented as methods, apparatus, systems, computing devices, and the like. As such, embodiments described herein may take the form of an apparatus, system, computing device, and the like executing instructions stored on a computer readable storage medium to perform certain steps or operations. Thus, embodiments described herein may be implemented entirely in hardware, entirely in a computer program product, or in an embodiment that comprises combination of computer program products and hardware performing certain steps or operations.

Embodiments described herein may be made with reference to block diagrams and flowchart illustrations. Thus, it should be understood that blocks of a block diagram and flowchart illustrations may be implemented in the form of a computer program product, in an entirely hardware embodiment, in a combination of hardware and computer program products, or in apparatus, systems, computing devices, and the like carrying out instructions, operations, or steps. Such instructions, operations, or steps may be stored on a computer readable storage medium for execution buy a processing element in a computing device. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. A method comprising, by a processor of a robotic device:
identifying one or more machine states of the robotic device and a status of each of the one or more machine states, wherein the one or more machine states are selected from at least one of the following: a navigation state, a sensor function state, a collision alert state, or an error state;
selecting at least one of the one or more machine states;
determining a visual pattern corresponding to a status of the at least one selected machine state; and
causing a plurality of light emitting modules of the robotic device to output the visual pattern.

2. The method of claim 1, wherein selecting the at least one of the one or more machine states comprises making the selection based on one or more of the following:
a priority level associated with each of the one or more machine states;
a priority level associated with the status of each of the one or more machine states;
mode of operation of the robotic device; or
user instructions.

3. The method of claim 1, wherein determining the visual pattern comprises identifying, corresponding to the status of the at least one machine state, one or more of the following characteristics of the visual pattern:
one or more colors of light in the visual pattern;
intensity of light in the visual pattern;
shape of light in the visual pattern;
identification of the plurality of light emitting modules; or
variations in one or more characteristics of the light pattern over time.

4. The method of claim 1, wherein:
the navigation state corresponds to a movement of the robotic device; and
a status in the navigation state provides information about at least one of the following: direction of movement, impending turns, or impending stops during the movement of the robotic device.

5. The method of claim 1, wherein:
the sensor function state corresponds to a machine state of the robotic device in which one or more of a plurality of sensors of the robotic device are activated; and
a status in the sensor function state provides information about at least one of the following: identity of a sensor that is activated, location of the sensor on the robotic device, type of the sensor, distance of the robotic device from an object being sensed by sensor, location of an object being sensed by the sensor, or type of object being sensed by the sensor.

6. The method of claim 1, further comprising performing preventive maintenance of the robotic device by:
selecting the at least one machine state as the sensor function state;
operating the robotic device in an environment, wherein information about one or more objects in the environment is known before the operation of the robotic device;
receiving, from the robotic device, the visual pattern corresponding to the sensor function state of the robotic device;
determining whether at least one sensor of the robotic device has malfunctioned by analyzing the received visual pattern; and
outputting results of the determination.

7. The method of claim 6, wherein:
determining if the at least one sensor of the robotic device has malfunctioned by analyzing the received visual pattern comprises analyzing the visual pattern to determine information about at least one of the one or more objects in the environment detected by the at least one sensor of the robotic device; and
the information includes one or more of the following: distance of the robotic device from the at least one object, location of the at least one object relative to the robotic device, or type of the at least one object.

8. The method of claim 7, wherein determining if the at least one sensor of the robotic device has malfunctioned by analyzing the received visual pattern comprises:
comparing the information about the at least one object with the corresponding known information; and
determining that the at least one sensor has malfunctioned if the information about the at least one object with the corresponding known information do not match.

9. The method of claim 1, further comprising performing calibration of one or more sensors of the robotic device using the visual pattern.

10. The method of claim 1, wherein:
the collision alert state corresponds to a machine state of the robotic device in which the robotic device may collide with an object within a threshold time; and
a status in the collision alert state provides information about at least one of the following: distance of the robotic device from the object, location of the object relative to the robotic device, or type of user intervention needed.

11. The method of claim 1, wherein:
the error state corresponds to a machine state of the robotic device in which the at least one component of the robotic device is not functioning as expected; and
a status in the error state provides information about at least one of the following: identity of the at least one component, time duration in the error state, or criticality of an error.

12. The method of claim 1, further comprising, using the outputted visual pattern during LiDAR calibration of a LiDAR sensor included in the robotic device.

13. The method of claim 12, wherein using the outputted visual pattern during LiDAR calibration of the LiDAR sensor included in the robotic device comprises:
causing one or more of the plurality of light emitting modules of the robotic device to output a first visual pattern in response to detecting an object located at a distance that is equal to a detection range of the LiDAR sensor; and
causing one or more of the plurality of light emitting modules of the robotic device to output a second visual pattern in response to not detecting the object, wherein a height of the object is equal to a height of a focal plane of the LiDAR sensor with respect to a surface on which the robotic device is placed.

14. A method for performing preventive maintenance of a robotic device, the method comprising:
operating the robotic device in an environment, wherein information about one or more objects in the environment is known before the operation of the robotic device; and
by a processor:
receiving, from the robotic device, a visual pattern corresponding to a status of at least one sensor of the robotic device;
by the processor, determining whether the at least one sensor of the robotic device has malfunctioned by analyzing the received visual pattern; and
by the processor, outputting results of the determination.

15. The method of claim 14, wherein the status provides information about at least one of the following: whether or not the at least one sensor is activated, location of the at least one sensor on the robotic device, type of the at least one sensor, distance of the robotic device from an object being sensed by the at least one sensor, location of an object being sensed by the at least one sensor, or type of object being sensed by the at least one sensor:

16. The method of claim 14, wherein
determining if the at least one sensor of the robotic device has malfunctioned by analyzing the received visual pattern comprises analyzing the visual pattern to determine information about at least one of the one or more objects in the environment detected by the at least one sensor of the robotic device; and
the information includes one or more of the following: distance of the robotic device from the at least one object, location of the at least one object relative to the robotic device, or type of the at least one object.

17. The method of claim 16, wherein determining if the at least one sensor of the robotic device has malfunctioned by analyzing the received visual pattern comprises:
comparing the information about the at least one object with the corresponding known information; and
determining that the at least one sensor has malfunctioned if the information about the at least one object with the corresponding known information do not match.

18. A robotic device comprising:
a plurality of light emitting modules;
a processor; and
a non-transitory computer readable medium comprising programming instructions that when executed by the processor cause the processor to:
identify one or more machine states of the robotic device and a status of each of the one or more machine states, wherein the one or more machine states are selected from at least one of the following: a navigation state, a sensor function state, a collision alert state, or an error state;
select at least one of the one or more machine states;
determine a visual pattern corresponding to a status of the at least one selected machine state; and
cause the plurality of light emitting modules to output the visual pattern.

19. The robotic device of claim 18, wherein the programming instructions that when executed cause the processor to select the at least one of the one or more machine states further comprise programming instructions to cause the processor to make the selection based on one or more of the following:
a priority level associated with each of the one or more machine states;
a priority level associated with the status of each of the one or more machine states;
mode of operation of the robotic device; or
user instructions.

20. The robotic device of claim 18, wherein the programming instructions that when executed cause the processor to determine the visual pattern further comprise programming instructions to cause the processor to identify, corresponding to the status of the at least one machine state, one or more of the following characteristics of the visual pattern:
one or more colors of light in the visual pattern;
intensity of light in the visual pattern;
shape of light in the visual pattern;
identification of the plurality of light emitting modules; or
variations in one or more characteristics of the light pattern over time.

21. The robotic device of claim 18, wherein:
the navigation state corresponds to a movement of the robotic device; and
a status in the navigation state provides information about at least one of the following: direction of movement, impending turns, or impending stops during the movement of the robotic device.

22. The robotic device of claim 18, wherein:
the sensor function state corresponds to a machine state of the robotic device in which one or more of a plurality of sensors of the robotic device are activated; and
a status in the sensor function state provides information about at least one of the following: identity of a sensor that is activated, location of the sensor on the robotic device, type of the sensor, distance of the robotic device from an object being sensed by sensor, location of an object being sensed by the sensor, or type of object being sensed by the sensor.

23. The robotic device of claim 18, further comprising programming instructions that when executed cause the processor to perform calibration of one or more sensors of the robotic device using the visual pattern.

24. The robotic device of claim 18, wherein:
the collision alert state corresponds to a machine state of the robotic device in which the robotic device may collide with an object within a threshold time; and
a status in the collision alert state provides information about at least one of the following: distance of the robotic device from the object, location of the object relative to the robotic device, or type of user intervention needed.

25. The robotic device of claim 18, wherein:
the error state corresponds to a machine state of the robotic device in which the at least one component of the robotic device is not functioning as expected; and
a status in the error state provides information about at least one of the following: identity of the at least one component, time duration in the error state, or criticality of an error.
